(19) United States
(12) Patent Application Publication
(10) Pub. No.: US 2004/0190499 A1
(43) Pub. Date: Sep. 30, 2004

(54) Method and system for configuring gateways to facilitate a modem connection over a packet network

(75) Inventors: Zhihui Chen, Trabuco Canyon, CA (US); Keith Chu, Mission Viejo, CA (US)

Correspondence Address: FARJAMI & FARJAMI LLP, 26522 LA ALAMEDA AVENUE, SUITE 360, MISSION VIEJO, CA, 92691, US

(73) Assignee: Mindspeed Technologies, Inc.

(21) Appl. No.: 10/631,947

(22) Filed: Jul. 30, 2003

Related U.S. Application Data
(63) Continuation-in-part of application No. 10/104,304, filed on Mar. 22, 2002.
(60) Provisional application No. 60/288,151, filed on May 1, 2001.
(60) Provisional application No. 60/288,775, filed on May 4, 2001.

(51) Int. Cl. H04L 12/66

(52) U.S. Cl. 370/352

(57) ABSTRACT

There is provided system, device and method for use by a first gateway device to enable communication between a first modem and a second modem, the first gateway device being capable of communicating with the first modem over a first communication line, the first gateway device being capable of communicating with a second gateway device over a packet network, the second gateway device being capable of communicating with the second modem over a second communication line. An example method comprises receiving a call request for the first modem from the second gateway device, placing a call to the first modem, detecting an answer tone transmitted from the first modem over the first communication line in response to the call, detecting a phase reversal in the answer tone, and transmitting a message indicative of the phase reversal to the second gateway device over the packet network.

### RELATED APPLICATIONS

The present application is a continuation-in-part of U.S. application Ser. No. 10/104,304, filed Mar. 22, 2002, which claims the benefit of U.S. provisional application serial No. 60/288,151, filed May 1, 2001, and U.S. provisional application serial No. 60/288,775 filed May 4, 2001, which are hereby fully incorporated by reference in the present application.

### BACKGROUND OF THE INVENTION

1. Field of the Invention

The present invention relates generally to communications over packet networks. More particularly, the present invention relates to method and system for configuring gateways to facilitate a more robust modem connection over a packet network.

2. Related Art

In recent years, packet-based networks, such as the Internet, have begun to replace the traditional analog telephone networks for transportation of voice and data. For example, with the emergence of voice over IP (“VoIP”), telephone conversations may now be captured, packetized and transported over the Internet. In a conventional VoIP system, telephone conversations or analog voice may be transported over the local loop or the public switched telephone network (“PSTN”) to the central office (“CO”). From the CO, the analog voice is transported to a gateway device at the edge of the packet-based network. The gateway device converts the analog voice or speech to packetized data using a codec (coder/decoder), according to one of various existing protocols, such as G.729, G.711, G.723.1, etc. Next, the packetized data is transmitted over the Internet using the Internet Protocol for reception by a remote gateway device and conversion back to analog voice.

Today, many have diverted their focus to using the existing packet-based network and gateway devices, which have been designed to support the transportation of analog voice or speech over IP, to further support modem communication over IP, or as it is referred to in the industry, Modem over Internet Protocol (“MoIP”). FIG. 1 illustrates a block diagram of a conventional communication model for MoIP based on a packet-based network, such as the Internet. As shown, communication model 100 includes first modem (M1) 110 in communication with first gateway communication device (G1) 120 over PSTN providing transmit and receive channels 112 and 114. Communication model 100 further includes second modem (M2) 150 in communication with second gateway communication device 140 (G2) over PSTN providing transmit and receive channels 144 and 142.

The term modem stands for modulator-demodulator (i.e. digital-to-analog/analog-to-digital converter). Modem is a device that is capable of adapting a terminal or computer to an analog telephone line by converting digital pulses to audio frequencies and vice versa. Modems may support a variety of data modulation standards, such as ITU (International Telecommunications Union) standards: V.92, V.90, V.34, V.32bis, V.32, V.22bis, V.22, V.21 or Bell 103, specifications of which are hereby incorporated by reference. Typically, modems have built-in error correction, such as MNP2-4 and/or LAPM and data compression, such as MNP5, V.42bis or V.44. Modems are also capable of supporting various voice and facsimile standards.

Communication model 100 enables communications between first gateway communication device 120 and second gateway communication device 140 via packet network 130 utilizing the Internet Protocol. The Internet Protocol implements the network layer (layer 3) of a network protocol, which contains a network address and is used to route a message to a different network or subnetwork. The Internet Protocol further accepts packets from the layer 4 transport protocol, such as Transmission Control Protocol (“TCP”) or User Data Protocol (“UDP”), and adds its own header and delivers the data to the layer 2 data link protocol. TCP provides transport functions, which ensures that the total amount of bytes sent is received correctly at the other end. UDP, which is part of the TCP/IP suite, is an alternate transport that does not guarantee delivery and it is widely used for real-time voice and video transmissions where erroneous packets are not retransmitted.

Conventionally, the communication process for MoIP begins when M1 110 calls G1 120. As a result of receiving such call from M1 110, G1 120 calls G2 140, and G2 140 in turn calls M2 150. In order to support VoIP, in their default mode of operation, G1 120 and G2 140 start to communicate in voice mode and are configured to use a compressed voice protocol, such as the ITU standard G.723.1. However, when M2 150 answers the incoming call from G2 140, M2 150 generates an answer tone, e.g. a single tone at 2100 Hz, that causes G1 120 and G2 140 to switch to a higher quality voice protocol, such as an ITU standard G.711, which provides toll quality audio at 64 Kbps using either A-Law or mu-Law pulse code modulation methods. This digital format is used in order to allow easy connections to legacy telephone networks. By switching to G.711, the tones generated by M2 150 may propagate through G2 140 and G1 120 with less distortion in order to reach M1 110 at the other side. As a result of configuring G1 120 and G2 140 for a new mode of operation, which is commonly referred to as modem pass through mode, G1 120 and G2 140 facilitate a toll quality voice path, through which path, M1 110 and M2 150 may communicate with one another. In order to minimize the effect of network impairments, such as packet losses, jitter and delay, in the modem pass through mode, G1 120 and G2 140 further configure themselves to adjust the jitter buffer size, disable echo suppressors and disable echo cancellers.

Traditionally, G2 140 determines that M2 150 is a modem and switches to modem pass through mode as a result of detecting the answer tone that is transmitted by M2 150 after being placed off-hook in response to G2 140 call. Once G2 switches to pass through mode, the answer tone is transmitted to G1 120 using a higher quality voice coding algorithm, such as G.711, which encodes the answer tone for transmission by G2 140 to G1 120 over packet network 130. Further, once G1 120 detects the encoded answer tone from G2 140, G1 120 also switches to pass through mode.

As it is known in the art, a modem answer tone has different types, such as pure answer tone (ANS), amplitude-modulated answer tone (ANSam), phase-reversed answer tone (/ANS), and phase-reversed amplitude-modulated answer tone (/ANSam). ANSam is known to be a sinewave at 2100 Hz signal, which is amplitude modulated at 15 Hz, and is indicative of modem modulation capabilities according to ITU-T V.34, V.90 or V.92 standards. A phase-reversed answer tone also indicates high-speed modem modulation capabilities that are facilitated by standards such as ITU-T V.32, V.32bis, V.34, V.90 and V.92 or protocols such as K56.

Typically, upon the detection of the phase-reversed answer tone, network echo cancellers are disabled. It is known that network echo cancellers interfere with high-speed modem connections and may cause modems to fall back to lower speeds during the training and negotiation phase. Therefore, it is desirable that G1 120 and G2 140 disable their echo cancellers upon detection of a phase reversal in the answer tone. However, based on the existing implementations of the modem pass through mode, G1 120 does not detect the phase-reversed answer tone (/ANS or /ANSam) reliably due to network impairments and the fact that G1 receives an encoded version of the phase-reversed answer tone, which is encoded using a voice protocol, such as G.723.1, G.711, G.729 or the like. In the event that G1 120 fails to detect the phase reversal, G1 120 does not disable its echo canceller, and M1 110 and M2 150 connection speed may fallback to lower speeds as a result of the interference caused by the echo canceller of G1 120.

Accordingly, there is a strong need in the art to detect phase-reversed answer tone reliably to avoid gateway interference with modem communication.

### SUMMARY OF THE INVENTION

In accordance with the purpose of the present invention as broadly described herein, there is provided system, device and method for use by a first gateway device to enable communication between a first modem and a second modem, the first gateway device being capable of communicating with the first modem over a first communication line, the first gateway device being capable of communicating with a second gateway device over a packet network, the second gateway device being capable of communicating with the second modem over a second communication line.

In one aspect of the present invention, an example method comprises the steps of: receiving a call request for the first modem from the second gateway device over the packet network, placing a call to the first modem over the first communication line in response to the receiving step, detecting an answer tone transmitted from the first modem over the first communication line in response to the placing step, detecting a phase reversal in the answer tone, and transmitting a message indicative of the phase reversal to the second gateway device over the packet network. In a further aspect, the message is indicative of an answer tone with phase reversal or an amplitude-modulated answer tone with phase reversal. In another aspect, the method further comprises the step of transmitting a message indicative of the answer tone to the second gateway device over the packet network prior to the step of transmitting the message indicative of the phase reversal. Further, the second gateway device includes an echo canceller, and the method further comprises the step of disabling the echo canceller in response to receiving the message indicative of the phase reversal from the first gateway device.

In a separate aspect of the present invention, an example method comprises receiving a call from the first modem over the first communication line for the second modem from, placing a call request to the second gateway device over the packet network in response to the receiving step, receiving a message indicative of the phase reversal from the second gateway device over the packet network in response to the placing step, and disabling an echo canceller of the first gateway device in response to the step of receiving the message indicative of the phase reversal. In a further aspect, the message is indicative of an answer tone with phase reversal or the message is indicative of an amplitude-modulated answer tone with phase reversal. In another aspect, the method further comprises the step of receiving a message indicative of the answer tone from the second gateway device over the packet network prior to the step of receiving the message indicative of the phase reversal.

In other aspects, systems and devices of the present invention can perform one or more steps of the aforementioned methods.

These and other aspects of the present invention will become apparent with further reference to the drawings and specification, which follow. It is intended that all such additional systems, methods, features and advantages be included within this description, be within the scope of the present invention, and be protected by the accompanying claims.

### BRIEF DESCRIPTION OF DRAWINGS

The features and advantages of the present invention will become more readily apparent to those ordinarily skilled in the art after reviewing the following detailed description and accompanying drawings, wherein:

FIG. 1 illustrates a block diagram of a prior art communication model based on a packet network, such as the Internet, utilizing the Internet Protocol;

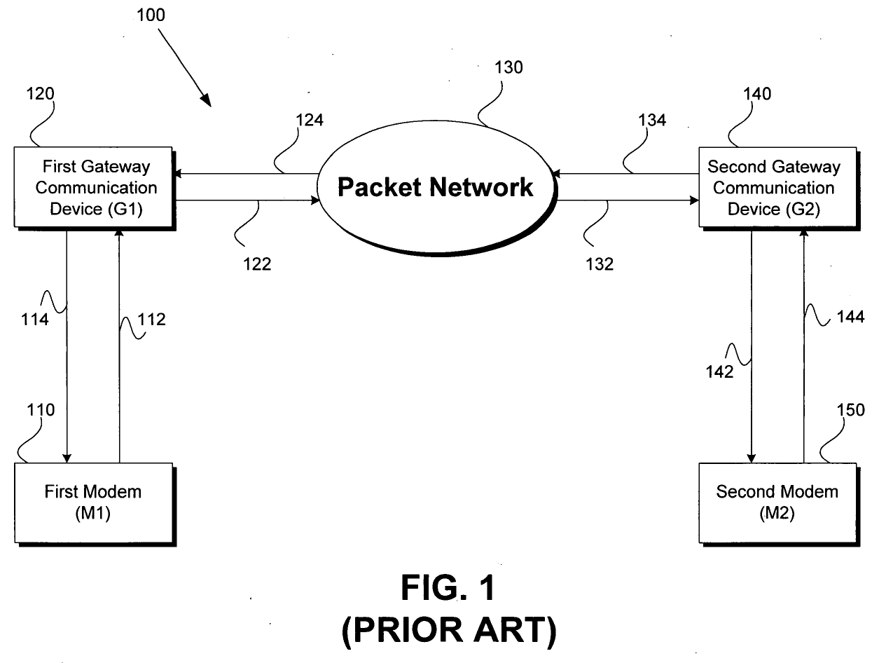

FIG. 2 illustrates a flow diagram of a communication method, according to one embodiment of the present invention, for establishing a modem connection over a packet network and gateways in pass through mode; and

FIG. 3 illustrates a block diagram of gateways for use by the communication method of FIG. 2.

### DESCRIPTION OF EXEMPLARY EMBODIMENTS

The present invention may be described herein in terms of functional block components and various processing steps. It should be appreciated that such functional blocks may be realized by any number of hardware components and/or software components configured to perform the specified functions. For example, the present invention may employ various integrated circuit components, e.g., memory elements, digital signal processing elements, transmitters, receivers, tone detectors, tone generators, logic elements, and the like, which may carry out a variety of functions under the control of one or more microprocessors or other control devices. Further, it should be noted that the present invention may employ any number of conventional techniques for data transmission, signaling, signal processing and conditioning, tone generation and detection and the like. Such general techniques that may be known to those skilled in the art are not described in detail herein.

It should be appreciated that the particular implementations shown and described herein are merely exemplary and are not intended to limit the scope of the present invention in any way. For example, although the present invention is described using a modem over IP network, it should be noted that the present invention may be implemented in other packet based communication networks and is not limited to modem over IP. Indeed, for the sake of brevity, conventional data transmission, tone generation and detection, encoding, decoding, signaling and signal processing and other functional aspects of the data communication system (and components of the individual operating components of the system) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical communication system.

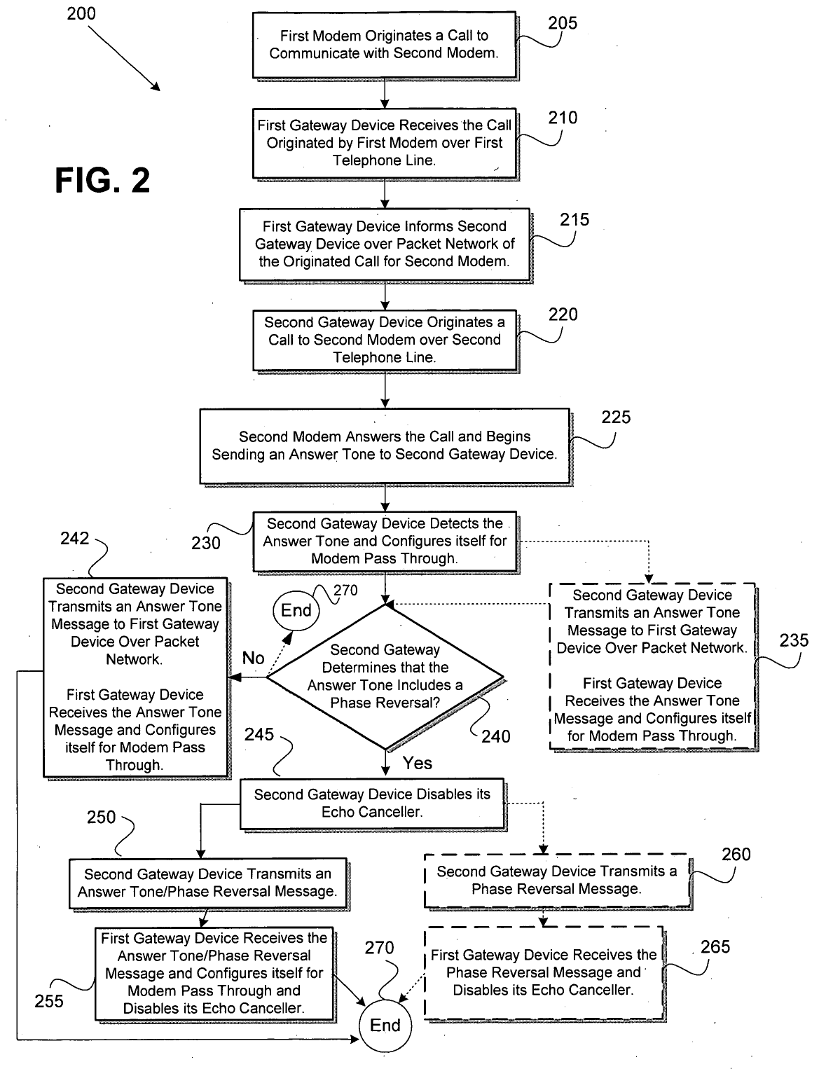

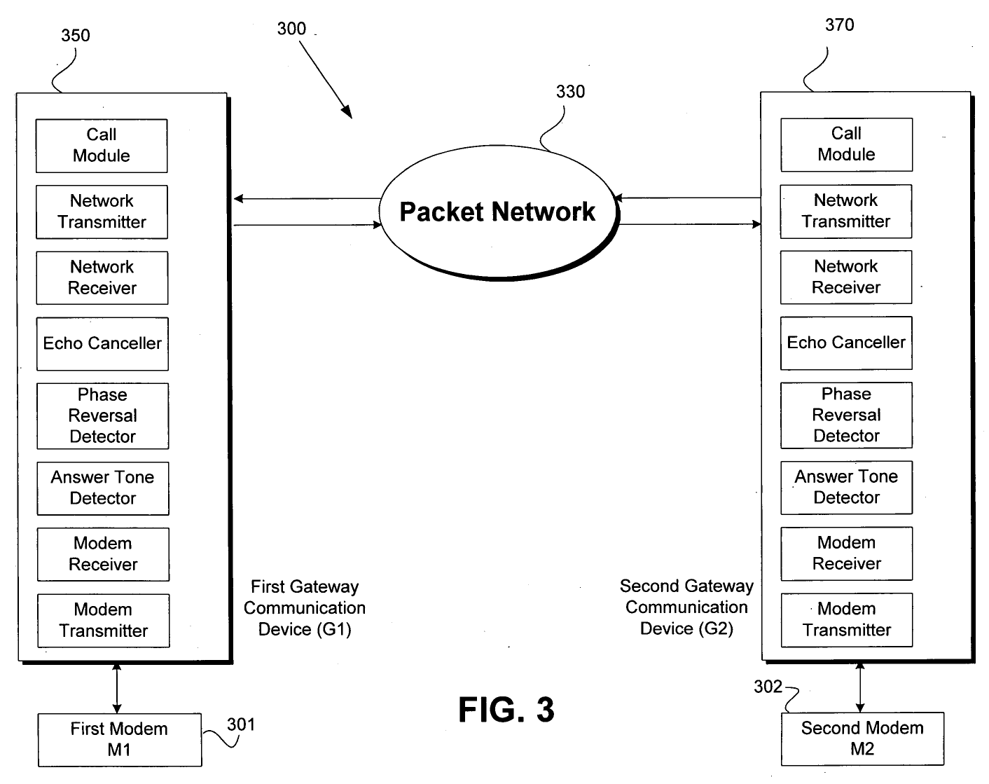

FIG. 2 illustrates a flow diagram of a communication method 200, according to one embodiment of the present invention, which is described below in conjunction with communication system 300 of FIG. 3. Communication method 200 illustrates an example algorithm, according to one embodiment, for establishing a modem connection between M1 301 and M2 302 over packet network 330 through first gateway device or G1 350 and second gateway device or G2 370.

Communication method 200 starts at step 205 where M1 301 initiates a call to communicate with M2 302 over packet network 330 and through G1 350 and G2 370. For example, M1 301 dials a phone number for M2 302 over a first communication line, such as a first telephone line. Next, at step 210, G1 350, which is the local gateway device of M1 301, receives the call from M1 301 over the first telephone line. At step 215, G1 350 informs G2 370, which is the local gateway device of M2 302, over packet network 330 of the received call for M2 302. In step 220, G2 370 originates a call to M2 302 over a second communication line, such as a second telephone line, for example, by dialing the phone number for M2 302. It should be noted that until this point of communication method 200, neither G1 350 nor G2 370 are aware that the calling entity or M1 301 and the answering entity or M2 302 are modem devices.

Next, at step 225, M2 302 receives the call from G2 370, and in response thereto, M2 302 goes off-hook and starts transmitting an answer tone. The answer tone is a tone with a predetermined frequency and format. Typically, the answer tone is a tone with a frequency of around 2100 Hz, a specified format, which may vary to indicate different standards or training protocols. For example, a phase-reversed answer tone, which is typically denoted by /ANS, indicates high-speed modem connections that are facilitated by standards such as ITU-T V.32, V.32bis, V.34, V.90 and V.92 or protocols such as K56. According to high-speed modem standards, the phase of the 2100 Hz answer tone is reversed every 450 milliseconds, which sounds like little clicks in the answer tone. These phase reversals are generated to inform the telephone network that the modems themselves are going to do echo cancellation, and that any echo cancellers in the telephone network itself should be disabled, so as not to interfere with the modem communications.

Turning to communication method 200, at step 230, G2 370 detects the answer tone that is transmitted by M2 302. G2 370 may detect the answer tone using a tone detector centered around 2100 Hz. Upon detection of the answer tone, G2 370 determines that the answering entity is a modem device, i.e. M2 302. At this point G2 370 configures itself for the modem pass through mode to facilitate a modem connection through G2 370. In one embodiment, in configuring itself for modem pass through mode, G2 370 may switch its voice encoding protocol to G.711, adjust its jitter buffer size, disable its echo canceller, disable its echo suppressor, etc. In one embodiment of the present invention, communication method 200 of the present invention moves to step 235, where G2 370 transmits an answer tone message to G1 350, across packet network 330, which informs G1 350 that G2 370 has detected an answer tone. Messages, such as the answer tone message, may be communicated between G1 350 and G2 370, over packet network 130, using the Internet Engineering Task Force's (“IETF”) Request For Comment 2833 (“RFC2833”). Further, for example, G2 370 may transmit SSE:ANS to G1 350 as an indication that G2 370 has detected an answer tone. Turning back to step 235, upon detection of the answer tone message, G1 350 also configures itself for the modem pass through mode to facilitate a modem connection through G1 350. In one embodiment, in configuring itself for modem pass through mode, G1 350 may switch its voice encoding protocol to G.711, adjust its jitter buffer size, disable its echo canceller, disable its echo suppressor, etc.

As shown in FIG. 2, communication method 200 may skip step 235 and move from step 230 directly to step 240. In step 240, G2 370 determines if the answer tone includes a phase reversal, i.e. /ANS or /ANSam. As stated above, according to existing standards, the phase of the answer tone is reversed every 450 milliseconds. If G2 determines that the answer tone includes a phase reversal, communication method 200 moves to step 245, otherwise, communication method 200 moves to step 242. At step 242, communication method 200 moves to step 270 to end the process if communication method 200 has already performed step 235, else communication method 200 performs the same actions as those described in step 235 (i.e. G2 370 transmits an answer tone message (SSE:ANS or SSE:ANSam) to G1 350, and G1 350 configures itself for modem pass through mode), and communication method 200 ends at step 270.

However, if G2 370 detects a phase reversal at step 240, communication method moves to step 245, where G2 370 disables its echo canceller in response to detecting the phase reversal indicative of /ANS or /ANSam, which is indicative of high-speed modem connection, in order to avoid interference with the modem communication between M1 301 and M2 302. Next, if G2 370 has already transmitted an answer tone message at step 235, communication method 200 moves to step 260 where G2 370 transmits a phase reversal message (SSE:PR) to G1 350 to indicate that G2 370 has detected phase reversals in the answer tone. Upon receiving the phase reversal message, G1 350 also disables its echo canceller in order to avoid interference with the modem communication between M1 301 and M2 302. However, if communication method 200 did not transmit the answer tone message at step 235, communication method 200 moves from step 245 to step 250 and transmits a phase-reversed answer tone message (SSE:/ANS or SSE:/ANSam if amplitude modulation is also detected) to G1 350. Upon receiving the phase-reversed answer tone message, G1 350 configures itself for modem pass through mode to facilitate a modem connection through G1 350, and G1 350 also disables its echo canceller in order to avoid interference with the modem communication between M1 301 and M2 302.

Because it takes one or more phase reversal periods to confirm that the answer tone includes a phase reversal at step 240, in one embodiment, which is shown by dashed lines in FIG. 2, G2 370 transmits two separate messages to G1 350, wherein the first one is the answer tone message (step 235) and the second one is the phase reversal message (step 260). In another embodiment, however, G2 370 may wait until the phase reversal determination is made at step 240, and then transmit a single message indicative of answer tone (step 242) or phase-reversed answer tone (step 250).

Various embodiment of the present invention can overcome the existing problems in the art, which are caused due to unreliable detection of the phase-reversed answer tone (/ANS or /ANSam) by G1 350. As described above, according to various embodiments of the present invention, G2 370 is capable of detecting the answer tone and its type reliably and transmitting messages to G1 350 indicative of detection of the answer tone and its type, and more specifically, the detection of a phase reversal type answer tone by G2 370. Accordingly, the modem over packet network communication between M1 301 and M2 302 does not have to rely upon the detection of the phase reversal by G1 350. As noted above, failure to detect the phase reversal leads to G1 350 enabling its echo canceller that can cause performance degradation in the modem communication between M1 301 and M2 302. Rather, according to one embodiment of the present invention, upon receipt of the phase reversal or the phase-reversed answer tone message from G2, G1 disables its echo canceller to prevent any interference with the modem communication between M1 301 and M2 302.

The methods and systems presented above may reside in software, hardware, or firmware on the device, which can be implemented on a microprocessor, digital signal processor, application specific IC, or field programmable gate array (“FPGA”), or any combination thereof, without departing from the spirit of the invention. Furthermore, the present invention may be embodied in other specific forms without departing from its spirit or essential characteristics. The described embodiments are to be considered in all respects only as illustrative and not restrictive.

What is claimed is:

1. A communication method for use by a first gateway device to enable communication between a first modem and a second modem, said first gateway device being capable of communicating with said first modem over a first communication line, said first gateway device being capable of communicating with a second gateway device over a packet network, said second gateway device being capable of communicating with said second modem over a second communication line, said method comprising the steps of:
receiving a call request for said first modem from said second gateway device over said packet network;
placing a call to said first modem over said first communication line in response to said receiving step;
detecting an answer tone transmitted from said first modem over said first communication line in response to said placing step;
detecting a phase reversal in said answer tone; and
transmitting a message indicative of said phase reversal to said second gateway device over said packet network.

2. The method of claim 1, wherein said message is indicative of an answer tone with phase reversal.

3. The method of claim 1, wherein said message is indicative of an amplitude-modulated answer tone with phase reversal.

4. The method of claim 1 further comprising the step of transmitting a message indicative of said answer tone to said second gateway device over said packet network prior to said step of transmitting said message indicative of said phase reversal.

5. The method of claim 4, wherein said message indicative of said phase reversal is a phase reversal message.

6. The method of claim 1, wherein said second gateway device includes an echo canceller, and the method further comprises the step of disabling said echo canceller in response to receiving said message indicative of said phase reversal from said first gateway device.

7. A first gateway device configured to enable communication between a first modem and a second modem, said first gateway device being capable of communicating with said first modem over a first communication line, said first gateway device being capable of communicating with a second gateway device over a packet network, said second gateway device being capable of communicating with said second modem over a second communication line, said first gateway device comprising:
a receiver configured to receive a call request for said first modem from said second gateway device over said packet network;
a call module configured to place a call to said first modem over said first in response to said receiver receiving said call request;
an answer tone detector configured to detect an answer tone transmitted from said first modem over said first communication line in response to said call;
a phase reversal detector configured to detect a phase reversal in said answer tone; and
a transmitter configured to transmit a message indicative of said phase reversal to said second gateway device over said packet network.

8. The first gateway device of claim 7, wherein said message is indicative of an answer tone with phase reversal.

9. The first gateway device of claim 7, wherein said message is indicative of an amplitude-modulated answer tone with phase reversal.

10. The first gateway device of claim 7, wherein said transmitter transmits a message indicative of said answer tone to said second gateway device over said packet network prior to transmitting said message indicative of said phase reversal.

11. The first gateway device of claim 10, wherein said message indicative of said phase reversal is a phase reversal message.

12. The first gateway device of claim 7, wherein said second gateway device includes an echo canceller, and said second gateway device disables said echo canceller in response to receiving said message indicative of said phase reversal from said first gateway device.

13. A communication method for use by a first gateway device to enable communication between a first modem and a second modem, said first gateway device being capable of communicating with said first modem over a first communication line, said first gateway device being capable of communicating with a second gateway device over a packet network, said second gateway device being capable of communicating with said second modem over a second communication line, said method comprising the steps of:
receiving a call from said first modem over said first communication line for said second modem from;
placing a call request to said second gateway device over said packet network in response to said receiving step;
receiving a message indicative of said phase reversal from said second gateway device over said packet network in response to said placing step; and
disabling an echo canceller of said first gateway device in response to said step of receiving said message indicative of said phase reversal.

14. The method of claim 13, wherein said message is indicative of an answer tone with phase reversal.

15. The method of claim 13, wherein said message is indicative of an amplitude-modulated answer tone with phase reversal.

16. The method of claim 13 further comprising the step of receiving a message indicative of said answer tone from said second gateway device over said packet network prior to said step of receiving said message indicative of said phase reversal.

17. The method of claim 16, wherein said message indicative of said phase reversal is a phase reversal message.

18. A first gateway device configured to enable communication between a first modem and a second modem, said first gateway device being capable of communicating with said first modem over a first communication line, said first gateway device being capable of communicating with a second gateway device over a packet network, said second gateway device being capable of communicating with said second modem over a second communication line, said first gateway device comprising:
a modem receiver configured to receive a call from said first modem over said first communication line for said second modem from;
a call module configured to place a call request to said second gateway device over said packet network in response to said call;
a network receiver configured to receive a message indicative of said phase reversal from said second gateway device over said packet network in response to said call request; and
an echo canceller, wherein said first gateway device disables said echo canceller in response to said message indicative of said phase reversal.

19. The first gateway device of claim 18, wherein said message is indicative of an answer tone with phase reversal.

20. The first gateway device of claim 18, wherein said message is indicative of an amplitude-modulated answer tone with phase reversal.

21. The first gateway device of claim 18, wherein said network receiver receives a message indicative of said answer tone from said second gateway device over said packet network prior to said network receiver receiving said message indicative of said phase reversal.

22. The first gateway device of claim 21, wherein said message indicative of said phase reversal is a phase reversal message.
